(19) United States
(12) Patent Application Publication
(10) Pub. No.: US 2026/0227291 A1
(43) Pub. Date: Aug. 6, 2026

(54) METHOD AND TEST SYSTEM FOR TESTING A DEVICE-UNDER-TEST

(71) Applicant: Rohde & Schwarz GmbH & Co. KG, Munich (DE)

(72) Inventor: Michael DREIMANN, Munich (DE)

(73) Assignee: Rohde & Schwarz GmbH & Co. KG, Munich (DE)

(21) Appl. No.: 19/042,454

(22) Filed: Jan. 31, 2025

(51) Int. Cl. G01M 99/00; G06K 19/06

(52) U.S. Cl. CPC G01M 99/005; G06K 19/06037

(57) ABSTRACT

The present disclosure relates to a method for testing a device-under-test, DUT. The method comprises: connecting the DUT to a test system; and retrieving a test profile for testing the DUT with the test system; wherein the step of retrieving the test profile comprises reading a two-dimensional code which is located on or displayed by the DUT, wherein the test profile is associated to the two-dimensional code; and wherein the test system is configured according to the retrieved test profile in order to test the DUT.

### TECHNICAL FIELD

The present disclosure relates to a method and a test system for testing a device-under-test (DUT).

### BACKGROUND ART

Test systems and instruments, such as oscilloscopes or RF spectrum analyzers, are commonly used for testing RF communication devices, e.g., in the context of product development or product testing. In such test systems and instruments various configurations can be adapted to the specific properties of the device-under-test (DUT).

When performing such measurements with a specific DUT, it is thus important to ensure that the test system or instrument is configured correctly for the DUT, i.e., according to the specific capabilities and properties of the DUT. Currently users need to manually adapt the configuration of a test system when a new DUT is connected, which is cumbersome and carries the risk of an incorrect configuration.

Accordingly, there is a need to provide a method and a system for testing a DUT which overcome the above mentioned disadvantages and limitations. In particular, there is a need to provide a faster and more reliable way of configuring a test system for testing a DUT.

### SUMMARY

According to a first aspect, the present disclosure relates to a method for testing a device-under-test (DUT). The method comprises: connecting the DUT to a test system; and retrieving a test profile for testing the DUT with the test system; wherein the step of retrieving the test profile comprises reading a two-dimensional code which is located on or displayed by the DUT, wherein the test profile is associated to the two-dimensional code. The test system is then configured according to the retrieved test profile in order to test the DUT.

This achieves the advantage that the test system can be configured in a fast and reliable manner for testing a specific DUT.

The test system can comprise or can be formed by a test and/or measurement instrument. For instance, the test system comprises a radio communication tester, a signal analyzer, a vector network analyzer, a signal generator, and/or an oscilloscope.

The DUT can be a radio frequency (RF) communication device. For instance, the DUT is a smartphone or other user equipment.

The test profile can define various configuration data for configuring the test system in order to test the DUT. The test profile can be a specific test profile for the DUT, e.g. for the class or type of the DUT. For instance, the test profile comprises data on the class or type of the DUT and/or on measurements to be carried out with the DUT. When switching between different DUTs, the correct test profile for each new DUT can be loaded in the test system by reading the respective code on the DUT.

The DUT can be connected to the test system via a wire or in a wireless manner (e.g., for over-the-air testing).

In an implementation form, the test profile is retrieved from a database in which the test profile is associated with the two-dimensional code or with information encoded by the two-dimensional code. The test profile may then be forwarded from the database to the test system.

In an implementation form, the database is stored in a local data repository of the test system.

In an implementation form, the database is stored in a central data repository which is accessed by at least one further test system. For instance, the at least one further test system is another test system which is also capable of retrieving test profiles from the database for testing DUTs.

In an implementation form, the two-dimensional code is read by a reading device which is communicatively connected to the database.

In an implementation form, the two-dimensional code is a QR code.

In an implementation form, the two-dimensional code is printed on the DUT.

In an implementation form, the two-dimensional code is printed on an element that is physically attached to the DUT. For instance, the two-dimensional code is printed on a sticker which is glued to the DUT.

In an implementation form, the two-dimensional code is stored in a memory of the DUT and is displayed on a display element of the DUT.

For example, the DUT comprises a screen configured for displaying the two-dimensional code.

According to a second aspect, the present disclosure relates to a test system for testing a device-under-test (DUT). The test system comprises: an interface which is arranged for being connected to the DUT and a reading device. The test system is configured to retrieve a test profile for testing the DUT, wherein the retrieval of the test profile comprises reading a two-dimensional code which is located on or displayed by the DUT by means of the reading device, wherein the test profile is associated to the two-dimensional code; and wherein the test system is adapted to be configured according to the retrieved test profile in order to test the DUT.

### BRIEF DESCRIPTION OF THE DRAWINGS

Exemplary embodiments of the disclosure are now further explained with respect to the drawings by way of example only, and not for limitation. In the drawings:

FIG. 1 shows a flow diagram of a method for testing a DUT according to an embodiment; and

FIG. 2 shows a schematic diagram of a test system for testing a DUT according to an embodiment.

### DETAILED DESCRIPTIONS OF EMBODIMENTS

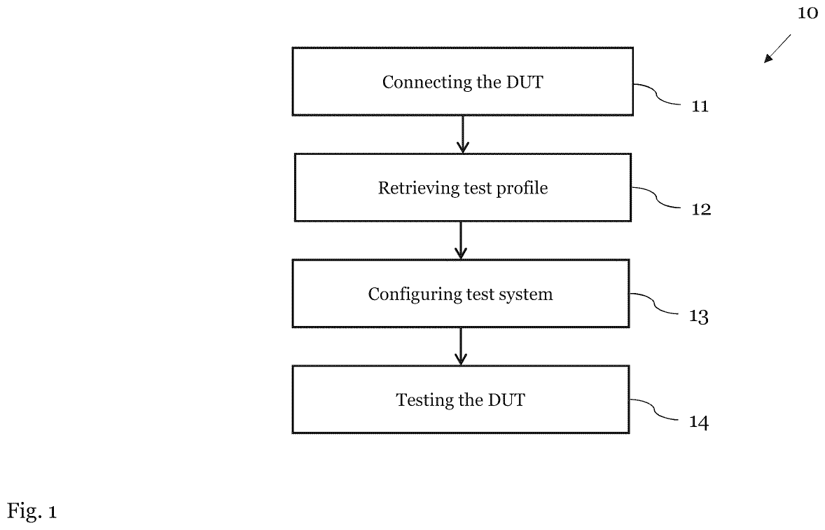

FIG. 1 shows a flow diagram of a method 10 for testing a DUT according to an embodiment.

The method 10 comprises the steps of: connecting 11 the DUT to a test system; and retrieving 12 a test profile for testing the DUT with the test system; wherein the step of retrieving 12 the test profile comprises reading a two-dimensional code which is located on or displayed by the DUT, wherein the test profile is associated to the two-dimensional code. The test system is then configured 13 according to the retrieved test profile in order to test the DUT.

The method 10 may comprise the further step of testing 14 the DUT with the thus configured test system.

The test system can comprise or can be formed by a test and/or measurement instrument. For instance, the test system comprises a radio communication tester, a signal analyzer, a vector network analyzer, a signal generator, and/or an oscilloscope.

The DUT can be a radio frequency (RF) communication device. For instance, the DUT is a smartphone or other user equipment.

The test profile can be a specific test profile for the DUT, e.g. for the class or type of the DUT. The test profile can define various configuration data for configuring the test system in order to test the DUT. These configurations can be managed as the test profiles allowing to load the correct configuration data in the test system or instrument when switching between different DUTs.

For instance, the test profile comprises data on the class or type of the DUT and/or on measurements to be carried out with the DUT. In addition or alternatively, the test profile can comprise information on antenna connectors, frequency bands, SIM profiles (e.g., SIM card or eSIM), and/or automation commands for the test system.

The DUT can be manually connected 11 to the test system via a wire. Alternatively, the DUT can be connected to the test system in a wireless manner (e.g., for over-the-air testing).

The test profile can be retrieved 12 from a database. For instance, in the database, the test profile is associated with the two-dimensional code or with information encoded by the two-dimensional code, e.g., an identifier encoded by the two-dimensional code. Thus, based on the two-dimensional code or information encoded by the code, the database can determine (e.g., select) the test profile which is associated to the code and forward said test profile to the test system.

The database can be stored in a local data repository of the test system. For instance, the test system comprises a memory for storing the database.

Alternatively, the database is stored in a central data repository which can be accessed by a plurality of test systems which are capable of retrieving test profiles from the database for testing DUTs. For instance, the test system is connected to the central data repository via a communication network (e.g., the internet).

In yet another alternative, test profile data could be stored in the QR code itself, such that no additional database is required.

The two-dimensional code can be read by a reading device, such as a code reader or smartphone with code reader functionality. The reading device can be communicatively connected to the database and/or to the test system. The code reader can also be a component of the test system.

The step of configuring 13 the test system may comprise configuring the test system specifically to the profile specific to the DUT. For instance, an automation profile is thereby executed by the test system. Software for configuring the test system can be stored locally by the system (e.g., on a test instrument), in the cloud or on an external computer.

Deviating from the sequence shown in FIG. 1, the step 11 of connecting the DUT could also be carried out after step 12 or 13.

For instance, if a further DUT is to be tested with the test system, the steps 11-14 of the method 10 can be repeated for the further DUT, wherein a test profile for the further DUT can be retrieved.

In an example, the two-dimensional code is a QR code.

The two-dimensional code (e.g., the QR code) may be directly printed on a surface of the DUT.

The two-dimensional code can also be printed on an element that is physically attached to the DUT. For instance, the two-dimensional code is printed on a sticker which is glued to the DUT.

Alternatively, the two-dimensional code is stored in a memory of the DUT and is displayed on a display element of the DUT. The display element can be a screen of the DUT.

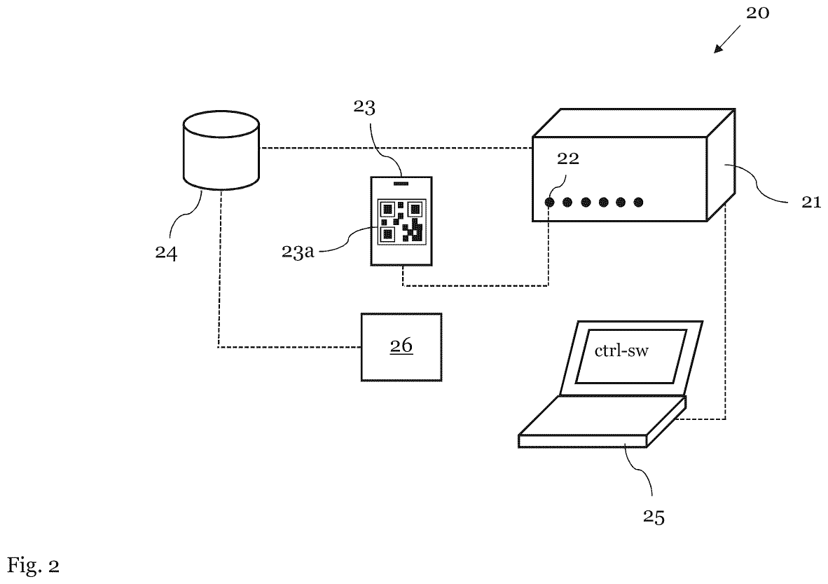

FIG. 2 shows a schematic diagram of the test system 20 for testing the DUT 23 according to an embodiment.

The test system 20 comprises an interface 22 which is arranged for being connected to the DUT 23 and a reading device 26, wherein the test system 20 is configured to retrieve a test profile for testing the DUT 23. This retrieval of the test profile comprises reading the two-dimensional code which is located on or displayed by the DUT 23 by means of the reading device, 26 wherein the test profile is associated to the two-dimensional code. The test system 20 is then adapted to be configured according to the retrieved test profile in order to test the DUT 23.

The exemplary test system 20 shown in FIG. 2 comprises a test instrument 21, e.g. a radio communication tester. The interface 22 for connecting the DUT 23 can be formed by a test port of the instrument 21. The test system 20 can be controlled by a test system software. This software may be provided by an external computer 25 which is connected to the instrument 21. The retrieved test profile can be used by the test instrument and/or the test system software in order to configure the instrument 21 and/or the software according to the profile.

The test profile can be associated with a unique identifier (GUID) which is exported as and/or encoded by the two-dimensional code. This code can be stored on the DUT 23 or printed out as a sticker to be put on the DUT 23 (or directly printed on the DUT 23). When connecting the DUT 23 to the test instrument, scanning of the code may trigger loading the correct DUT test profile to the test equipment (e.g., the test instrument of the system 20).

In the example shown in FIG. 2, the two-dimensional code is a QR code 23a which is displayed on a screen of the DUT 23 (e.g., a user equipment or smartphone). The QR code 23a can be stored in a code storage of the DUT 23. For instance, the DUT 23 can be configured to execute an application software (e.g., a digital wallet) for selecting and displaying the QR code.

The test profile can be retrieved from a database 24 which is e.g. stored in a central data repository, as shown in FIG. 2. The database 24 can be communicatively connected to the test system 20 and/or the reading device 26 and can store test profiles for a plurality of different DUTs and/or test systems together with associated 2D codes (or the identifiers encoded by the codes). Such a central storage of test profiles facilitates moving a DUT from one test system to another, each time identifying the correct profile and loading this profile from the central storage on the respective test system.

The retrieval of the test profiles and the configuration of the test system 20 after reading of the two-dimensional code can be carried out fully automatically without requiring any user input. This leads to an enhanced ease of use and prevents mix ups of test profiles. Furthermore, the test system can switch in a faster and simpler way between different (types of) DUTs.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the present disclosure may have been disclosed with respect to only one of several implementations, such feature may be combined with one or more other features of the other implementations as may be desired and advantageous for any given or particular application.

1. A method for testing a device-under-test, DUT, comprising:
connecting the DUT to a test system; and
retrieving a test profile for testing the DUT with the test system;
wherein the step of retrieving the test profile comprises reading a two-dimensional code which is located on or displayed by the DUT, wherein the test profile is associated to the two-dimensional code; and
wherein the test system is configured according to the retrieved test profile in order to test the DUT.

2. The method of claim 1,
wherein the test profile is retrieved from a database in which the test profile is associated with the two-dimensional code or with information encoded by the two-dimensional code.

3. The method of claim 2,
wherein the database is stored in a local data repository of the test system.

4. The method of claim 2,
wherein the database is stored in a central data repository which is accessed by at least one further test system.

5. The method of claim 2,
wherein the two-dimensional code is read by a reading device which is communicatively connected to the database.

6. The method of claim 1,
wherein the two-dimensional code is a QR code.

7. The method of claim 1,
wherein the two-dimensional code is printed on the DUT.

8. The method of claim 1,
wherein the two-dimensional code is printed on an element that is physically attached to the DUT.

9. The method of claim 1,
wherein the two-dimensional code is stored in a memory of the DUT and is displayed on a display element of the DUT.

10. A test system for testing a device-under-test, DUT, comprising:
an interface which is arranged for being connected to the DUT; and
a reading device;
wherein the test system is configured to retrieve a test profile for testing the DUT;
wherein the retrieval of the test profile comprises reading a two-dimensional code which is located on or displayed by the DUT by means of the reading device, wherein the test profile is associated to the two-dimensional code; and
wherein the test system is adapted to be configured according to the retrieved test profile in order to test the DUT.
